(19) United States
(12) Patent Application Publication
(10) Pub. No.: US 2025/0206015 A1
(43) Pub. Date: Jun. 26, 2025

(54) RECORDING ELEMENT SUBSTRATE, RECORDING HEAD, AND RECORDING APPARATUS

(71) Applicant: CANON KABUSHIKI KAISHA, Tokyo (JP)

(72) Inventor: KENJI FUKADA, Tokyo (JP)

(21) Appl. No.: 18/984,291

(22) Filed: Dec. 17, 2024

(30) Foreign Application Priority Data
Dec. 20, 2023 (JP) 2023-214606

(51) Int. Cl. B41J 2/045; B41J 2/14

(52) U.S. Cl. CPC B41J 2/04543; B41J 2/04541; B41J 2/0455; B41J 2/04573; B41J 2/0458; B41J 2/14072; B41J 2002/14491

(57) ABSTRACT

Provided is an element substrate, including: a plurality of recording elements for discharging liquid; a plurality of first drive elements for driving the plurality of recording elements; a first control circuit for outputting first control signals for controlling the plurality of first drive elements; a plurality of inverter circuits for delaying input of the first control signals such that the first control signals are input at different timings among the plurality of first drive elements; a plurality of heat generating elements for heating the element substrate; a plurality of second drive elements for driving the plurality of heat generating elements; a second control circuit for outputting second control signals for controlling the plurality of second drive elements; and a plurality of flip-flop circuits for delaying input of the second control signals such that the second control signals are input at different timings among the plurality of second drive elements.

### BACKGROUND

### Field

The present disclosure relates to an element substrate, a recording head, and a recording apparatus.

### Description of the Related Art

Types of recording heads (liquid ejection heads) used for liquid ejection type recording apparatuses as typified by inkjet printers include a heat ejection type and a piezoelectric element type. In the heat ejection type recording head, generally a plurality of recording elements (liquid ejection elements) for generating ejection energy for ink as recording liquid, a plurality of heat generating elements for heating a recording element substrate, and a plurality of nozzles are formed on a single recording element substrate (liquid ejection element substrate). In the heat ejection type recording head, it is necessary to apply stable voltage to each of a plurality of recording elements in order to eject ink from a plurality of ejection ports by using energy generated by the recording elements. To achieve stable ejection characteristics of each recording element, it is important to suppress temperature unevenness depending on positions on the recording element substrate. Thus, in order to uniform the temperature distribution in the recording element substrate, it is important to apply stable voltage to each heat generating element disposed in a particular area of the recording element substrate so as to implement heating.

For the plurality of recording elements and the heat generating elements, a plurality of drive elements are disposed correspondingly thereto respectively. The drive element is formed by a field effect transistor, and drives the recording element and the heat generating element by switching. When the plurality of recording elements and the heat generating elements are simultaneously driven, large current in the order of A (ampere) flows through drive power source wiring and ground wiring particularly at rising and falling of the supply of power.

Furthermore, the wiring length of drive power source wiring and the wiring length of ground wiring from the power source circuit and the recording element substrate disposed in the main body of the recording apparatus are large, and parasitic inductance components are large. If large current flows through the parasitic inductance components during driving, ringing occurs. Due to the ringing, a potential difference temporarily occurs between the ground wiring and the recording element substrate ground wiring. Due to the potential difference, a parasitic transistor of a field effect transistor as a drive element is turned on, and as a result, large current in the order of A (ampere) flows through the parasitic transistor, thereby causing a problem in that the drive element erroneously operates.

Japanese Patent Application Publication No. 2017-213806 discloses a technology in which, as a drive circuit for a heat generating element, a delay circuit is introduced in a circuit configuration, in which the heat generating element is driven by inputting a sub heat data signal to a plurality of drive elements on the basis of reception of a latch signal, thereby delaying the latch signal or the sub heat data signal.

In Japanese Patent Application Publication No. 2017-213806, a latch signal or a sub heat data signal is delayed to shift power supply rising and falling timings among a plurality of heat generating elements, thereby suppressing the values of currents flowing therethrough.

In recent years, a large number of recording elements are necessary with high density for the purpose of high image quality, and hence delay circuits need to be disposed with narrow intervals for delay at a large number of locations. On the other hand, if heat generating elements are finely disposed, the amount of control data and the circuit scale increase. To avoid this problem, it is common practice to reduce the number of systems by high power. Thus, the delay circuits for the heat generating elements are disposed at a smaller number of locations than that of the delay circuits for the recording elements, but a delay time by each delay circuit needs to be large. If such the delay configuration for such requirements is implemented by, for example, using in common a delay circuit for a heat generating element and a delay circuit for a recording element, there is a problem in that the circuit area in the recording element substrate increases.

### SUMMARY

It is an object of the present disclosure to provide a technology capable of improving area efficiency of a circuit in a recording element substrate that stabilizes ejection operation of a recording head by a delay circuit.

In order to achieve the above-mentioned object, an element substrate of the present disclosure includes a plurality of recording elements for discharging liquid, a plurality of first drive elements provided correspondingly to the plurality of recording elements, and driving the plurality of recording elements, a first control circuit for outputting first control signals for controlling the plurality of first drive elements, a plurality of inverter circuits for delaying input of the first control signals such that the first control signals are input at different timings among the plurality of first drive elements; a plurality of heat generating elements for heating the element substrate, a plurality of second drive elements provided correspondingly to the plurality of heat generating elements, and driving the plurality of heat generating elements, a second control circuit for outputting second control signals for controlling the plurality of second drive elements, and a plurality of flip-flop circuits for delaying input of the second control signals such that the second control signals are input at different timings among the plurality of second drive elements.

According to the present disclosure, area efficiency of a circuit in a recording element substrate that stabilizes ejection operation of a recording head by a delay circuit can be improved.

Further features of the present disclosure will become apparent from the following description of exemplary embodiments with reference to the attached drawings.

### BRIEF DESCRIPTION OF THE DRAWINGS

FIG. 1 is a schematic perspective view illustrating a configuration example of a recording apparatus according to an embodiment of the present disclosure;

FIG. 2 is a diagram illustrating an example of a control configuration of the recording apparatus according to the embodiment of the present disclosure;

FIG. 3 is a diagram illustrating a configuration example of a recording head according to a first embodiment;

FIG. 4 is a diagram illustrating a circuit configuration example of recording element substrate according to the first embodiment;

FIG. 5 is a diagram illustrating a circuit layout example of the recording element substrate according to the first embodiment;

FIG. 6 is a timing chart of a latch signal delay circuit;

FIG. 7 is a timing chart of a heat enable pulse delay circuit; and

FIG. 8 is a diagram illustrating a circuit configuration example of a recording element substrate according to a second embodiment.

### DESCRIPTION OF THE EMBODIMENTS

Referring to the drawings, modes for embodying the present disclosure are exemplarily described in detail below on the basis of examples. However, the dimensions, materials, shapes, and relative arrangement of components described in the embodiments should be changed as appropriate depending on configurations of devices and various conditions to which the present disclosure is applied. In other words, the scope of the present disclosure is not intended to be limited to the following embodiments.

Furthermore, a plurality of features is described in each embodiment described below, but not all the plurality of features is essential for the disclosure, and the plurality of features may be freely combined. In addition, in the accompanying drawings, the same or similar configurations in the embodiments are denoted by the same reference numbers, and duplicated descriptions are omitted.

Note that “recording” (sometimes referred to as “printing”) as used herein is not limited to the case of forming meaningful information such as characters and figures, irrespective of whether information is meaningful or unmeaningful. Furthermore, irrespective of whether information is so visible that humans can visually perceive, “recording” widely refers to the case of forming images, designs, or patterns on a recording medium or processing a medium. The “recording medium” refers to not only paper used for a general recording apparatus but also widely ink acceptable media such as cloths, plastic films, metal plates, glass, ceramics, wood, and leather.

Furthermore, “ink” (sometimes referred to as “liquid”) should be widely interpreted similarly to the above definition of the “recording (printing)”. Thus, “ink” refers to liquid that can be supplied to forming of images, design, and patterns, processing of a recording medium, or treatment of ink (for example, solidification or insolubilization of color agent in ink supplied to recording medium) when applied onto a recording medium. Furthermore, a “recording element” collectively refers to an element for generating energy used for an ejection port or a liquid channel communicating thereto and ink ejection unless otherwise specified. Furthermore, a “nozzle” collectively refers to an element for generating energy used for an ejection port or a liquid channel communicating thereto and ink ejection unless otherwise specified.

A recording head element substrate (head substrate) as used below refers to not only a simple substrate formed of silicon semiconductor but also a configuration in which each element and wiring are provided. Furthermore, “on a substrate” refers to not only “simply on an element substrate” but also “a surface of an element substrate and an inner side of an element substrate in the vicinity of the surface”.

In an inkjet recording head (hereinafter referred to as “recording head”), which constitutes the most important feature of the present disclosure, a plurality of recording elements and a drive circuit for driving the recording elements are mounted on the same element substrate of the recording head. As understood from the description later, the recording head has a structure in which a plurality of element substrates is incorporated and the element substrates are cascade-connected. Thus, the recording head can achieve a relatively long recording width. Therefore, the recording head is used for not only a commonly used serial type recording apparatus but also a recording apparatus including a full-line recording head whose recording width corresponds to the width of a recording medium. Among serial type recording apparatus, the recording head is used for a large format printer using a large-sized recording medium such as A0 and B0.

### First Embodiment

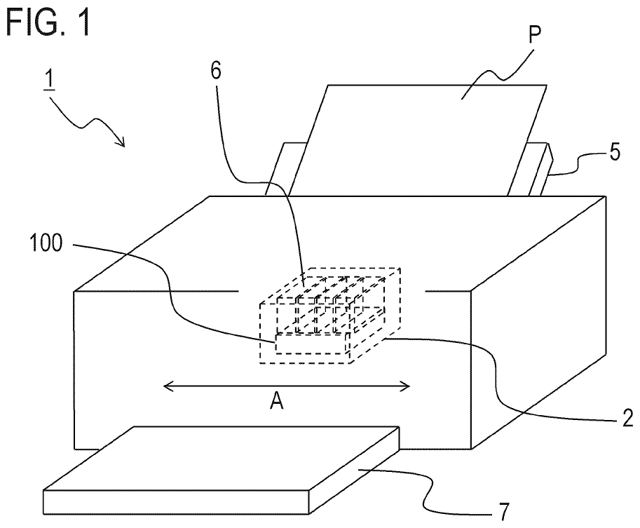

FIG. 1 is an external perspective view illustrating the outline of a configuration of an inkjet recording apparatus (hereinafter referred to as “recording apparatus”) for recording using an inkjet recording head (hereinafter referred to as “recording head”) as an example of a representative embodiment of the present disclosure.

As illustrated in FIG. 1, in a recording apparatus 1, a recording head 100 for recording by discharging ink in accordance with an inkjet type is mounted in a carriage 2, and the carriage 2 is reciprocated in a direction of the arrow A for recording. Recording is performed in a manner that a recording medium P such as recording paper is fed through a feed mechanism 5 and conveyed to a recording position, and ink is ejected from the recording head 100 to the recording medium P at the recording position. The recording medium P that has been subjected to the recording is discharged onto a discharge tray 7.

In the carriage 2 of the recording apparatus 1, not only the recording head 100 is mounted but also an ink tank 6 for storing ink to be supplied to the recording head 100 therein is mounted. The ink tank 6 is detachably attached to the carriage 2. The recording apparatus 1 illustrated in FIG. 1 can perform color recording, and hence in the carriage 2, four ink cartridges that respectively store ink of magenta (M), cyan (C), yellow (Y), and black (K) therein are mounted. The four ink cartridges are independently detachably attached.

The recording head 100 according to the disclosure of the present application employs an inkjet type for ejecting ink by using thermal energy. Thus, the recording head 100 includes a thermoelectric conversion element. The thermoelectric conversion element is provided correspondingly to each ejection port, and by applying a pulse voltage to a corresponding thermoelectric conversion element in accordance with a recording signal, ink is ejected from a corresponding ejection port. Note that the recording apparatus is not limited to the above-mentioned serial type recording apparatus, and is also applicable to what is called a full-line type recording apparatus in which a recording head (line head) having ejection ports arranged in a width direction of a recording medium is disposed in a conveying direction of the recording medium.

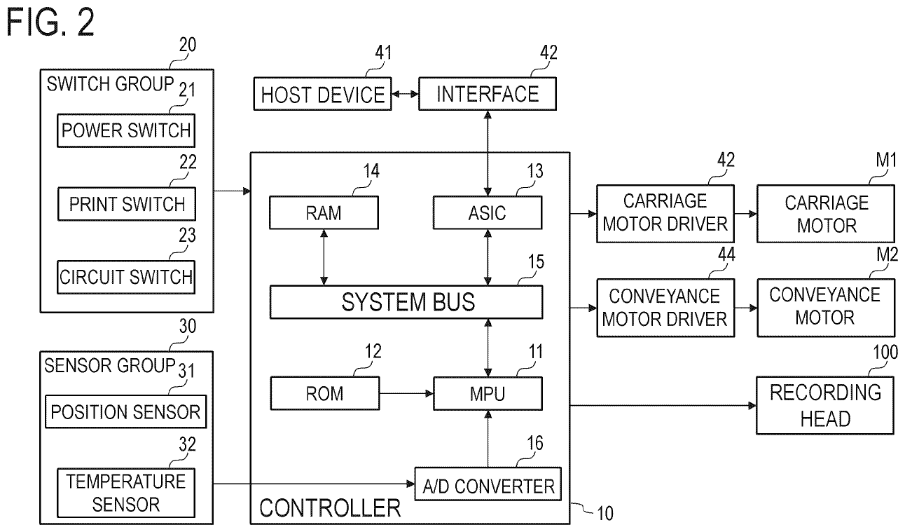

FIG. 2 is a block diagram illustrating a control configuration of the recording apparatus illustrated in FIG. 1.

As illustrated in FIG. 2, a controller 10 includes an MPU 11, a ROM 12, an application specific integrated circuit (ASIC) 13, a RAM 14, a system bus 15, and an A/D converter 16. The ROM 12 stores therein programs corresponding to various control sequences, necessary tables, and other fixed data. The ASIC 13 generates control signals for controlling a carriage motor M1, a conveyance motor M2, and the recording head 100. The RAM 14 is used as a deploy area for image data and a work area for program execution. The system bus 15 connects the MPU 11, the ASIC 13, and the RAM 14 to one another for transmission and reception of data. The A/D converter 16 inputs an analog signal from a sensor group described below, and performs A/D conversion to supply a digital signal to the MPU 11.

Furthermore, in FIG. 2, a host device 41 is an external information processing device such as a PC serving as a supply source for image data. Image data, commands, and statuses are transmitted and received between the host device 41 and the recording apparatus 1 through an interface (I/F) 42 by packet communication. Note that an USB interface may be additionally provided as the interface 42 differently from a network interface, and bit data and raster data serially transferred from a host.

A switch group 20 includes a power switch 21, a print switch 22, and a recovery switch 23.

A sensor group 30 is a sensor group for detecting apparatus states, and includes a position sensor 31 and a temperature sensor 32. In addition, a photosensor for detecting the remaining amount of ink is provided.

A carriage motor driver 43 is a carriage motor driver for driving the carriage motor M1 for reciprocating and scanning the carriage 2 in the direction of the arrow A. A conveyance motor driver 44 is a conveyance motor driver for driving the conveyance motor M2 for conveying the recording medium P.

The ASIC 13 transfers data for driving a heat generating element (ink ejection heater) to the recording head 100 while directly accessing the storage area of the RAM 14 in the recording and scanning by the recording head 100. In addition, the recording apparatus 1 includes a display portion configured by an LCD or an LED as a user interface.

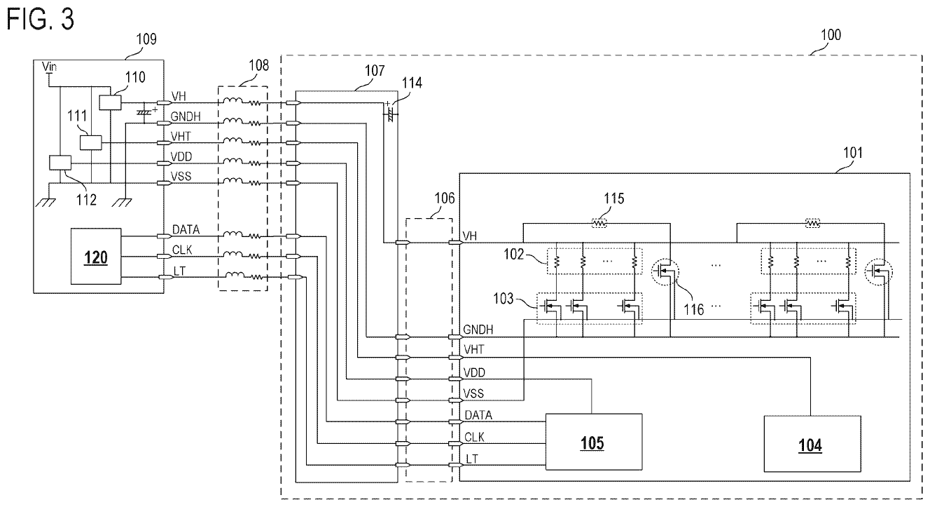

FIG. 3 illustrates a configuration example of the recording head 100 in the recording apparatus 1 according to the first embodiment of the present disclosure.

The recording head 100 includes a recording element substrate 101, a flexible substrate 106, and a printed wiring board 107. The recording element substrate 101 is electrically connected to the printed wiring board 107 through the flexible substrate 106. The printed wiring board 107 is electrically connected to a head control substrate 109 disposed on the main body side of the recording apparatus 1 through a cable 108.

The recording element substrate 101 is described in detail. The recording element substrate 101 includes a plurality of recording elements 102, a plurality of drive elements 103, a control gate 104, a logic circuit 105, a heat generating element 115, and a drive element 116. In the present embodiment, the recording element substrate 101 includes a semiconductor layer, a wiring layer, and an insulating layer.

The recording elements 102 are a recording element group for heating and discharging ink. The drive elements 103 are a recording element drive element group (first drive element group) for driving the recording elements 102. The plurality of recording elements 102 and the plurality of drive elements 103 are divided into a plurality of blocks (plurality of systems). As the drive element 103, a field effect transistor (FET) is mainly used. The control gate 104 is a control gate group for controlling the drive elements 103.

The logic circuit 105 is a logic circuit (first control circuit) for transmitting a control signal (first control signal) to the control gate 104. The logic circuit 105 is mainly configured by a latch circuit for holding recording data, a shift register circuit, and an HE generation circuit for generating a heat enable signal (HE) that determines a conduction time of the drive element. Details of the circuits are described later. The logic circuit 105 receives various signals transmitted from a head control IC 120. The various signals correspond to a data signal (DATA), a clock signal (CLK), and a latch signal (LT). Note that the head control IC 120 is disposed on the head control substrate 109.

The heat generating element 115 is an element for heating a particular area of the recording element substrate 101, and is used to heat the recording element substrate 101 to such a degree that ink is not discharged by the heating (sub heater). The drive element 116 is a heat generating element drive element (second drive element) for driving the heat generating element 115. The heat generating elements 115 and the drive elements 116 are disposed in each of the above-mentioned plurality of blocks.

In the present embodiment, the recording element drive element 103 and the heat generating element drive element 116 are provided in the same semiconductor layer. Furthermore, in the present embodiment, the drive element 103 and the drive element 116 use N-type field effect transistors.

One end of the recording element 102 is connected to a power source (VH) for supplying driving power. The other end of the recording element 102 is connected to a drain terminal of an FET as the drive element 103. Similarly to the recording element 102, one of the heat generating element 115 is connected to the power source (VH), and the other end thereof is connected to a drain terminal of an FET as the drive element 116. Furthermore, source terminals of the drive element 103 and the drive element 116 are connected to recording element ground wiring (GNDH), and substrate terminals (back gates) thereof are connected to substrate ground wiring (VSS). A power source of the control gate 104 is connected to control gate power wiring (VHT), and a power source of the logic circuit 105 is connected to logic circuit power wiring (VDD). Ground terminals of the control gate 104 and the logic circuit 105 are connected to the substrate ground wiring (VSS).

The recording element power source (VH) and the recording element ground (GNDH) for driving the recording element 102 and the heat generating element 115 are connected to a power source circuit 110 on the head control substrate 109. These power sources are generated by the power source circuit 110, and are supplied to the recording element substrate 101 through the cable 108, the printed wiring board 107, and the flexible substrate 106. The recording element ground wiring (GNDH) and the substrate ground wiring (VSS) are separated in the recording head 100, and are short-circuited on the head control substrate 109. In this manner, electromagnetic noise that is generated when the plurality of recording elements 102 and the heat generating element 115 are driven is prevented from propagating through the substrate ground wiring (VSS), thereby preventing erroneous operation of the logic circuit.

Depending on constraints of arrangement of the head control substrate 109 and the recording head 100 in the recording apparatus 1, the wiring length of the cable 108 may be 1 m or more, and accordingly the value of parasitic inductance increases. Specifically, the value takes several hundreds of nH to the order of 1 μH only by the cable 108. In order to reduce ringing between VH and GNDH generated by large parasitic inductance of the cable 108, a capacitor 114 is provided between VH and GNDH on the printed wiring board 107. As the capacitor 114, for example, an electrolytic capacitor of about several hundreds of μF is used.

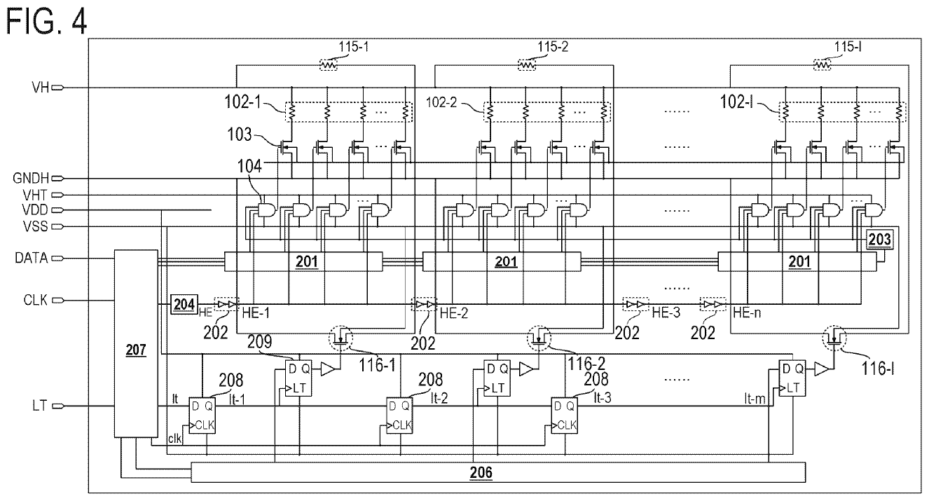

FIG. 4 is a diagram illustrating a detailed circuit configuration example of the recording element substrate 101 according to the first embodiment. Note that, in FIG. 4, when there are a plurality of the same components, indices are further added to the reference numbers.

A logic circuit 207 is a logic circuit for receiving various kinds of signals transmitted from the head control IC 120 and allocating data to predetermined places. A recording element group selection logic circuit 201 is a recording data shift register and latch circuit for holding recording data, and holds recording data in response to a latch signal (lt). A recording element block selection logic circuit 203 is a logic circuit for making the control gates 104 active in units of time-divided blocks, and holds a block selection signal.

An HE generation circuit 204 is a circuit for generating a heat enable signal (HE) that determines a conduction time of the drive element 103. A heat enable pulse delay circuit 202 includes at least one inverter circuit, and is a heat enable pulse delay circuit (first delay circuit) for delaying the heat enable signal (HE) by several ns to several tens of ns.

The arrangement of the plurality of heat enable pulse delay circuits 202 illustrated in the present embodiment is merely an example. For example, the number of the disposed heat enable pulse delay circuits 202 may be different among a plurality of groups formed by a plurality of recording elements 102.

The plurality of control gates 104 input delayed heat enable pulses (HE-1, HE-2, . . . , HE-n) delayed by the heat enable pulse delay circuit 202, respectively. The control gate 104 outputs recording data, a block selection signal, and a heat data signal as a result of logical AND of heat enable signals (HE). Thus, timings at which heat enable signals (HE) are input to the plurality of control gates 104 are each delayed by several ns to several tens of ns. Then, when a heat data signal is input to a gate of the drive element 103, ON/OFF is controlled, and the drive element 103 becomes conductive or nonconductive at the same time when the drive element 103 is turned on. Thus, timings at which the plurality of recording elements 102 are driven are each delayed by several ns to several tens of ns. In other words, when input of a heat enable signal (HE) to the control gate 104 is delayed by the heat enable pulse delay circuit 202, input of the heat data signal from the control gate 104 to the drive element 103 is delayed. In this manner, heat data signals are input among a plurality of blocks of the drive elements 103 at different timings.

A heat generating element latch circuit 209 is a sub heat data signal latch circuit for holding a sub heat data signal, which is a signal for defining whether to drive a heat generating element 115 belonging to a corresponding block. A heat generating element shift register circuit 206 is a sub heat data signal shift register circuit for transferring a sub heat data signal. A latch signal delay circuit 208 is a latch signal delay circuit (second delay circuit) configured by at least one flip-flop circuit, for delaying a latch signal by several ns to several hundreds of ns depending on the cycle of the clock signal×the number of stages of the flip-flop circuit. In the present embodiment, a D flip-flop circuit is used for the latch signal delay circuit 208. However, the latch signal delay circuit 208 may be an RS, JK, or T flip-flop circuit.

The arrangement of the plurality of latch signal delay circuits 208 illustrated in the present embodiment is merely an example. In other words, the number of the disposed latch signal delay circuits 208 may be different among a plurality of groups formed by a plurality of recording elements 102. Alternatively, the configuration is not limited to the one in which the latch signal delay circuit 208 is disposed for each heat generating element latch circuit 209, and a single latch signal delay circuit 208 may be disposed for each of a plurality of heat generating element latch circuits 209. In other words, the heat enable pulse delay circuit 202 may be disposed for each of a plurality of groups of a plurality of recording elements 102, and the latch signal delay circuit 208 may be disposed as a common delay circuit for some of the above-mentioned plurality of groups. Thus, a circuit configuration in which the number of flip-flop circuits constituting the latch signal delay circuit 208 is smaller than the number of inverter circuits constituting the heat enable pulse delay circuit 202 can be employed.

The plurality of heat generating element latch circuits 209 each output a sub heat data signal on the basis of a delayed latch signal (lt-1, lt-2, . . . , lt-m) delayed by the latch signal delay circuit 208 as a second control circuit. Thus, timings at which the plurality of heat generating element latch circuits 209 output sub heat data signals are each delayed by several ns to several tens of ns. Then, when a sub heat data signal is input to a gate of the drive element 116, ON/OFF is controlled, and the drive element 116 becomes conductive or nonconductive at the same time when the drive element 116 is turned on. Thus, timings at which the plurality of heat generating elements 115 are driven are each delayed by several ns to several tens of ns. In other words, when input of a latch signal to the heat generating element latch circuit 209 is delayed by the latch signal delay circuit 208, input of the sub heat data signal from the heat generating element latch circuit 209 to the drive element 116 is delayed. In this manner, sub heat data signals are input among a plurality of drive elements 116 disposed in each block at different timings.

When the above-mentioned configuration is employed, the plurality of recording elements 102 need to be delayed by disposing delay circuits at a large number of locations with narrow intervals, and hence an inverter circuit whose size and delay are small is suitable. On the other hand, the number of systems of the heat generating elements 115 is smaller than that of the plurality of recording elements 102, and the number of locations to provide delays is smaller, but it is necessary to provide a large delay interval in terms of power. Thus, a flip-flop circuit capable of providing a delay with a small number of circuits is suitable.

From the above, by employing different delay systems for the plurality of recording elements 102 and the heat generating element 115, the area efficiency is expected to improve.

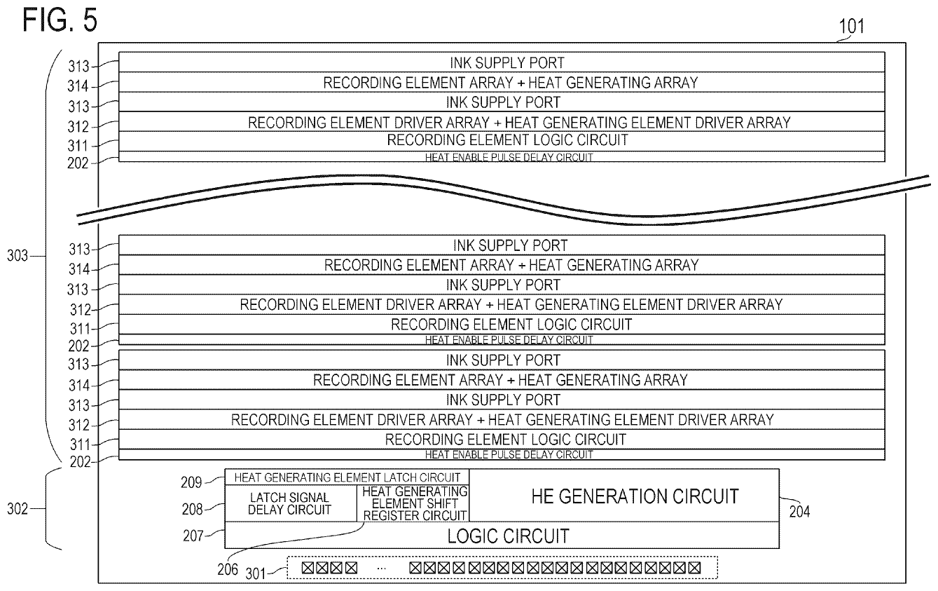

FIG. 5 is a diagram illustrating an example of circuit layout of the recording element substrate 101 according to the embodiment.

The recording element substrate 101 includes an input/output portion 301, an end portion circuit 302, and a nozzle row circuit 303. The input/output portion 301 is a pad portion for inputting and outputting power, signals, and information between the head control substrate 109 and the main body of the recording apparatus 1 to which the recording head 100 is mounted through the cable 108, the printed wiring board 107, and the flexible substrate 106. The end portion circuit 302 is a circuit portion disposed in the vicinity of the input/output portion 301. The nozzle row circuit 303 is a circuit portion disposed in a nozzle row of the recording head 100 to which the recording element substrate 101 is mounted. The nozzle row itself may be a plurality of rows instead of a single row.

The end portion circuit 302 includes an HE generation circuit 204, a heat generating element shift register circuit 206, a logic circuit 207, a latch signal delay circuit 208, and a heat generating element latch circuit 209. The nozzle row circuit 303 includes a heat enable pulse delay circuit 202, a recording element logic circuit 311, a recording element driver array and heat generating element driver array 312, an ink feeding port 313, and a recording element array and heat generating element array 314. The recording element logic circuit 311 includes a control gate 104 and recording element group selection logic circuit 201 and a recording element block selection logic circuit 203. The recording element driver array and heat generating element driver array 312 includes a drive element 103 and a drive element 116. The recording element array and heat generating element array 314 includes a recording element 102 and a heat generating element 115.

Due to the above-mentioned configuration, the area of each flip-flop circuit in the latch signal delay circuit 208 is large, and if the flip-flop circuit is provided in the nozzle row circuit 303, the width between rows is increased. Thus, the flip-flop circuit is disposed at the end portion circuit 302. The area of each inverter circuit in the heat enable pulse delay circuit 202 is small, but the inverter circuits need to be provided at a large number of locations, and hence if the inverter circuits are collectively provided at the end portion circuit 302, the area is increased. Thus, the heat enable pulse delay circuits 202 are disposed discretely among row groups of the plurality of recording elements 102 in the nozzle row circuit 303. From the above, the components are disposed at appropriate locations, and hence the area efficiency improves.

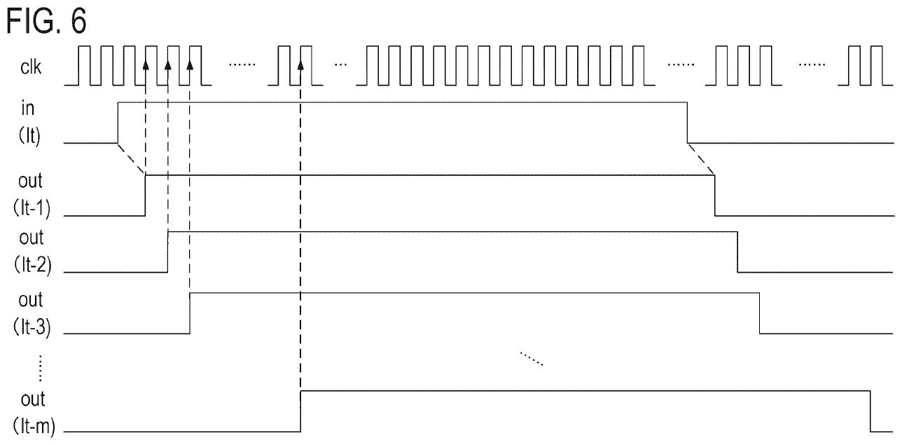

FIG. 6 is a timing chart of the latch signal delay circuit 208 in FIG. 4.

In the present embodiment, in the recording element substrate 101, time division driving is performed in such a manner that recording of one line is divided into a predetermined number of blocks and the heat generating elements 115 are sequentially driven. In this case, a line time indicates a time for recording an image (line) of one row or one line on a recording medium. A block time indicates a time necessary for recording of each block with reference to a block, and each line time corresponds to a time necessary for recording of the above-mentioned predetermined number of blocks (predetermined number of block times). Furthermore, a latch signal (LT) is a signal for identifying each block.

To heat and eject a minute amount of ink (for example, 1 picoliter) in one nozzle, a drive time of the recording element 102 may be a relatively short time such as several hundreds of n (nano) seconds. Thus, the recording element 102 is driven by a heat enable signal (HE) having a high frequency. On the other hand, the heat generating element 115 needs to heat and keep warming a particular area of the element substrate having a large heat capacity, and hence the drive time needs to be as long as several tens of u (micro) seconds to several hundreds of m (milli) seconds. Thus, the heat generating element 115 needs to be driven by a signal having a relatively low frequency.

The latch signal delay circuit 208 receives a latch signal (lt) from the logic circuit 207, and sequentially outputs delayed latch signals (lt-1, lt-2, . . . , lt-m) obtained by delaying the latch signal at each rising of clk. The interval of the delay depends on the frequency of clk, and is about several ns to several tens of ns.

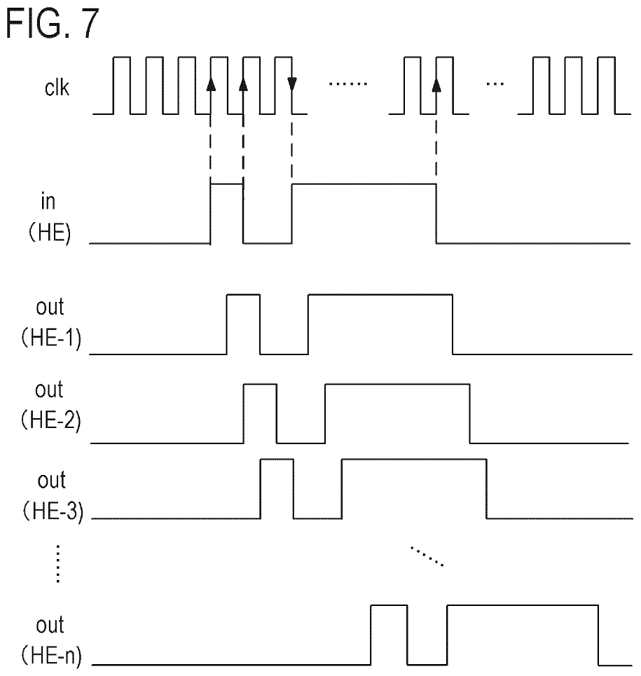

FIG. 7 is a timing chart of the heat enable pulse delay circuit 202 in FIG. 4.

In the HE generation circuit 204, a heat enable signal (HE) set by using rising and falling of a clk signal is generated. The heat enable pulse delay circuit 202 receives the heat enable signal (HE) from the HE generation circuit 204, and sequentially outputs delayed heat enable pulses (HE-1, HE-2, . . . , HE-n). The interval of the delay does not depend on the frequency of clk, and is an interval (several ns to several tens of ns) shorter than the latch signal delay circuit 208. The illustrated heat enable signal (HE) is an example, and the width can be freely changed by a set value.

The clk cycle illustrated in FIG. 7 is larger than the delay amount of the heat enable pulse delay circuit 202. Thus, the delay interval of the flip-flop circuit in the latch signal delay circuit 208 depends on the clk cycle, and hence a delay can be provided with an interval larger than that of the heat enable pulse delay circuit 202.

The delay times of the latch signal delay circuit 208 and the heat enable pulse delay circuit 202 illustrated in FIG. 6 and FIG. 7 are an example, and may be less than several ns or may be several hundreds of ns or more. Furthermore, the delay times may be different depending on locations.

Furthermore, the difference of the delay amounts of the clk cycle and the heat enable pulse delay circuit 202 is an example, and the delay amounts may be equal or the clk cycle may be smaller than that in the heat enable pulse delay circuit 202.

### Second Embodiment

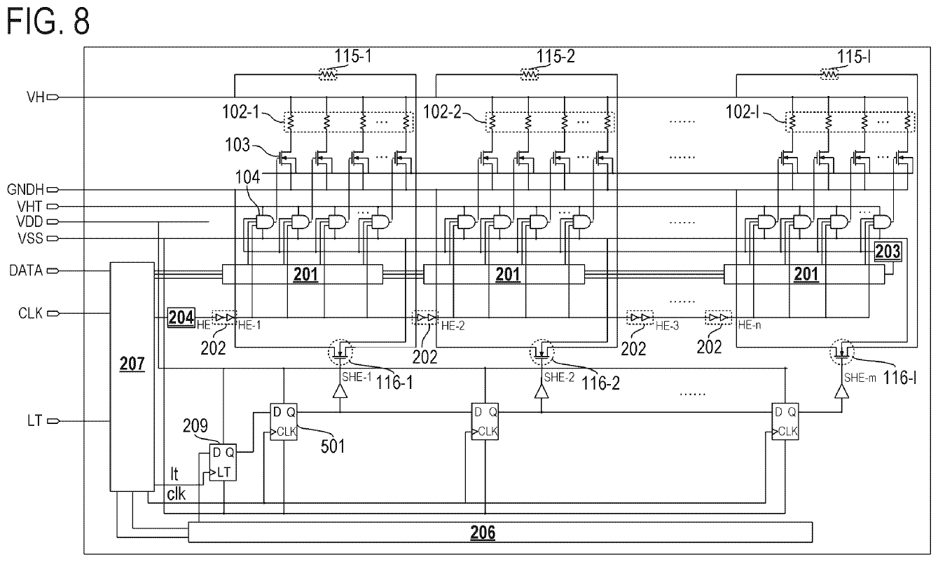

FIG. 8 is a diagram illustrating a detailed configuration example of a recording element substrate 101 according to a second embodiment of the present disclosure. The second embodiment is different from the first embodiment in that a plurality of sub heat data signal delay circuits 501 are provided. The other configurations are the same as in the first embodiment, and hence descriptions thereof are omitted.

In the present embodiment, the sub heat data signal delay circuit 501 receives, as input, a sub heat data signal output from the heat generating element latch circuit 209, and outputs delayed sub heat data signal (SHE-1, SHE-2, . . . , SHE-m) delayed by predetermined delay times. Then, when a delayed sub heat data signal is input to a gate of the drive element 116, ON/OFF is controlled, and the drive element 116 becomes conductive or nonconductive at the same time when the drive element 116 is turned on. Thus, timings at which the plurality of heat generating elements 115 are driven are each delayed by several ns to several tens of ns. In other words, input of a sub heat data signal from the heat generating element latch circuit 209 to the drive element 116 is delayed by the sub heat data signal delay circuit 501. In this manner, sub heat data signals are input among a plurality of drive elements 116 disposed in each block at different timings.

Similarly to the latch signal delay circuit 208 in the first embodiment, the sub heat data signal delay circuit 501 is configured by a flip-flop circuit, and is disposed at the end portion circuit 302. In this manner, the area efficiency improves.

The arrangement of the plurality of sub heat data signal delay circuit 501 illustrated in the present embodiment is merely an example. For example, the number of the disposed sub heat data signal delay circuits 501 may be different among a plurality of groups formed by a plurality of recording elements 102. In other words, the heat enable pulse delay circuit 202 may be disposed for each of a plurality of groups of a plurality of recording elements 102, but the sub heat data signal delay circuit 501 may be disposed as a common delay circuit for some of the above-mentioned plurality of groups. Thus, a circuit configuration in which the number of flip-flop circuits configuring the sub heat data signal delay circuit 501 is smaller than the number of inverter circuits configuring the heat enable pulse delay circuit 202 may be employed.

### Others

The forms and numbers of various components and various numerical values described in each of the above-mentioned embodiments are not limited to the ones described above, and can be changed as appropriate depending on the configuration of the recording element substrate.

For example, four recording elements 102 are illustrated in one group of the recording elements 102, and the illustration of more recording elements 102 is omitted. The number of nozzles included in a nozzle row corresponding to one group may be, for example, 512. The number of nozzle rows may be one or a plurality of rows.

The configurations in the above-mentioned embodiments can be combined with each other.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-214606, filed on Dec. 20, 2023, which is hereby incorporated by reference herein in its entirety.

What is claimed is:

1. An element substrate, comprising:
a plurality of recording elements for discharging liquid;
a plurality of first drive elements provided correspondingly to the plurality of recording elements, and driving the plurality of recording elements;
a first control circuit for outputting first control signals for controlling the plurality of first drive elements;
a plurality of inverter circuits for delaying input of the first control signals such that the first control signals are input at different timings among the plurality of first drive elements;
a plurality of heat generating elements for heating the element substrate;
a plurality of second drive elements provided correspondingly to the plurality of heat generating elements, and driving the plurality of heat generating elements;
a second control circuit for outputting second control signals for controlling the plurality of second drive elements; and
a plurality of flip-flop circuits for delaying input of the second control signals such that the second control signals are input at different timings among the plurality of second drive elements.

2. The element substrate according to claim 1, wherein the number of the plurality of flip-flop circuits is smaller than the number of the plurality of inverter circuits.

3. The element substrate according to claim 1,
wherein the plurality of recording elements and the plurality of first drive elements are divided into a plurality of blocks, and
wherein the inverter circuit is disposed in each of the plurality of blocks, and delays the first control signals such that the first control signals are input among the plurality of blocks at different timings.

4. The element substrate according to claim 3, wherein the heat generating element, the second drive element, and the flip-flop circuit are disposed in each of the plurality of blocks.

5. The element substrate according to claim 4,
wherein the first control circuit receives a heat enable signal that determines a conduction time of the first drive element, and outputs, as the first control signal, recording data, a block selection signal, and a heat data signal that is logical AND of the heat enable signal, and
wherein the inverter circuit delays reception of the heat enable signal by the first control circuit.

6. The element substrate according to claim 5,
wherein the second control signal is a sub heat data signal output to the plurality of second drive elements in accordance with sub heat data that defines whether to drive the heat generating element in each of the plurality of blocks,
wherein the second control circuit outputs the sub heat data signal on the basis of reception of a latch signal, and
wherein the flip-flop circuit delays the latch signal or the sub heat data signal.

7. The element substrate according to claim 6, wherein a delay time of input of the first control signal by the inverter circuit is shorter than a delay time of input of the second control signal by the flip-flop circuit.

8. The element substrate according to claim 1, wherein the flip-flop circuit is a D flip-flop circuit.

9. The element substrate according to claim 1, wherein the plurality of inverter circuits is disposed in a nozzle row circuit corresponding to a nozzle row of a recording head to which the element substrate is mounted.

10. The element substrate according to claim 9, wherein the plurality of flip-flop circuits is disposed at an end portion circuit between an input/output portion for performing input and output from and to a recording apparatus, to which the recording head is mounted, and the nozzle row circuit.

11. The element substrate according to claim 1, wherein the plurality of recording elements and the plurality of heat generating elements are connected to common power source wiring.

12. The element substrate according to claim 1, wherein ground wiring of the plurality of recording element and ground wiring of the plurality of heat generating element are common.

13. A recording head, comprising the element substrate according to claim 1.

14. A recording apparatus for causing ink to be ejected from the recording head according to claim 13 to a recording medium so as to implement recording.
